(19) United States
(12) Patent Application Publication
(10) Pub. No.: US 2002/0055375 A1
(43) Pub. Date: May 9, 2002

(54) Antenna device

(76) Inventors: Osamu Kozakai, Kanagawa (JP); Yuichiro Saito, Chiba (JP)

Correspondence Address: JAY H. MAIOLI, Cooper & Dunham LLP, 1185 Avenue of the Americas, New York, NY, 10036, US

(21) Appl. No.: 09/962,262

(22) Filed: Sep. 24, 2001

(30) Foreign Application Priority Data
Sep. 27, 2000 (JP) P2000-293448

(51) Int. Cl. H04B 1/38

(52) U.S. Cl. 455/575; 455/90

(57) ABSTRACT

An antenna device for a portable telephone having a protection portion is provided. An antenna element of the antenna device protrudes from a housing of the portable telephone. The protection portion enables to prevent the antenna element from being touched with a hand of an user while the hand grips the housing of the portable telephone in use.

### BACKGROUND OF THE INVENTION

1. Field of the Invention

The present invention relates to an antenna device, and in particular, it relates to an antenna device for use in a portable communication device, which has a retractable rod type antenna element which can slide in/out a housing of the portable communication device, and prevents the rod type antenna element when protracted from being touched with hands of a user while in use.

2. Description of the Related Art

An antenna device which is retractable into a housing of a portable telephone is widely in use. FIG. 1 shows a perspective appearance of such an antenna device in the portable telephone. A top section 1 of the antenna device as defined between AA′ in the drawing has a semispherical upper member and a cylindrical lower member, and a helical antenna which is embedded therein (not shown). A joint 2 at the root of the top section 1 is provided to join the top section 1 and an antenna element 3 in a manner that they are electrically disconnected. The antenna element 3 which is a rod type monopole antenna can be slid in directions of arrows B and B′ through a hole 4a of a metal holder 4 which is jointed collinearly on the housing 11 of the portable telephone, thereby allowing the antenna element 3 to retract in the directions of arrows B and B′. The holder 4 is fixed firmly on the housing 11 with its screw 4b which is screwed into a screw hole 11a of the housing.

At a root of the antenna element 3, there is provided a stopper 5 made of metal having a diameter which is slightly larger than a diameter of the hole 4a of the holder 4 so that when the antenna element 3 is slid and protracted in the direction of arrow B, the stopper 5 is fitted into the hole 4a of the holder 4 to be seized therein. Further, the stopper 5 is electrically connected to the antenna element 3.

When the antenna element 3 is slid in the direction of arrow B′ and retracted into a hole lib in the housing 11, a sleeve 1a made of metal at the root of the top section 1 is fit into the hole 4a of the holder 4. Because the sleeve 1a is electrically connected to the helical antenna (not shown) embedded in the top section 1, when it is fitted into the hole 4a, a communication section (not shown) which is connected to the holder 4 is allowed to receive a radio wave received via the helical antenna embedded inside the top section 1.

Alternatively, when the antenna element 3 is slid in the direction of arrow B and protracted from the hole lib of the housing 11, the stopper 5 provided at the root of the antenna element 3 is fitted into the hole 4a of the holder 4, thereby allowing the communication section (not shown) which is connected to the holder 4 to receive a radio signal received via the antenna element 3.

Namely, the antenna device is comprised of two antennae to be used separately according to whether the antenna element 3 is retracted or protracted, including the helical antenna embedded in the top section which is used when the antenna element 3 is retracted into the hole lib of the housing 11 and the rod type monopole antenna which is used when the antenna element 3 is protracted.

However, the above-mentioned antenna device has such a problem that when the user protracts the antenna element 3 from the hole lib of the housing 11 attempting to establish communication, a hand 21 of the user is likely to touch the antenna element 3 upon gripping the housing 11 of the portable telephone. This causes for the antenna element 3 which is comprised of the monopole antenna to be deviated from its resonance frequency when the hand 21 or part of body of the user touches the antenna element, thereby impairing its antenna characteristics and deteriorating quality of communication of the portable telephone.

### SUMMARY OF THE INVENTION

The present invention has been made while considering the above-mentioned problem associated with the related art. The present invention enables to protect a rod type antenna element protracted from a housing of a portable telephone from being touched with a hand of a user.

An antenna device according to one aspect of the invention comprises: a rod type retractable antenna portion; a storage portion for storing the rod type antenna portion by sliding the same along its axial directions into a housing; and a protection portion which, when the antenna portion is retracted into the storage portion while allowing a top section of the antenna portion to be protruded from the housing, covers a part or all the top section for protection.

According to another aspect of the present invention, the protection portion may be formed separately from the housing.

According to still another aspect of the present invention, a joint portion, which is formed together with the protection portion and to be jointed with the housing, may be further provided.

Alternatively, according to still another aspect of the present invention, a joint portion, which is formed separately from the protection portion and to be jointed with the housing by penetrating through the protection portion so as to fit into the housing, may be further provided.

According to another aspect of the present invention, a portable telephone unit including the antenna device according to the present invention may be provided.

In the antenna device according to the invention, when the antenna portion is retracted into the storage portion while allowing the top section of the antenna portion protruding from the housing, a part or all the top section is covered with the protection portion so as to be protected.

### BRIEF DESCRIPTION OF THE DRAWINGS

The above and other objects, features and advantages of the present invention will become more apparent from the following description of the presently preferred exemplary embodiment of the invention taken in conjunction with the accompanying drawings, in which:

FIG. 1 is a schematic diagram showing an example of structure of a antenna device;

FIG. 2 is a schematic diagram showing an example of structure of an antenna device according to one embodiment of the invention;

FIG. 3A and FIG. 3B are schematic diagrams showing a side view of the antenna device shown in FIG. 2;

FIG. 4 is a perspective view showing an appearance of the antenna device with the antenna element of FIG. 2 protracted from the housing;

FIG. 5 is a schematic diagram showing another example of the antenna device of FIG. 2 embodying the invention;

FIG. 6 is a schematic diagram showing still another example of the antenna device of FIG. 2 embodying the invention;

FIG. 7 is a schematic diagram showing still further example of the antenna device of FIG. 2 embodying the invention;

FIG. 8 is a schematic diagram showing still more another example of the antenna device of FIG. 2 embodying the invention; and

FIG. 9 is a schematic diagram showing an arrangement of the antenna device embodying the invention wherein the protection portion and a holder shown in FIG. 2 are formed separately and assembled.

### DETAILED DESCRIPTION

With reference to FIG. 2, an antenna device fixed on a portable telephone unit and its construction according to one embodiment of the invention is disclosed.

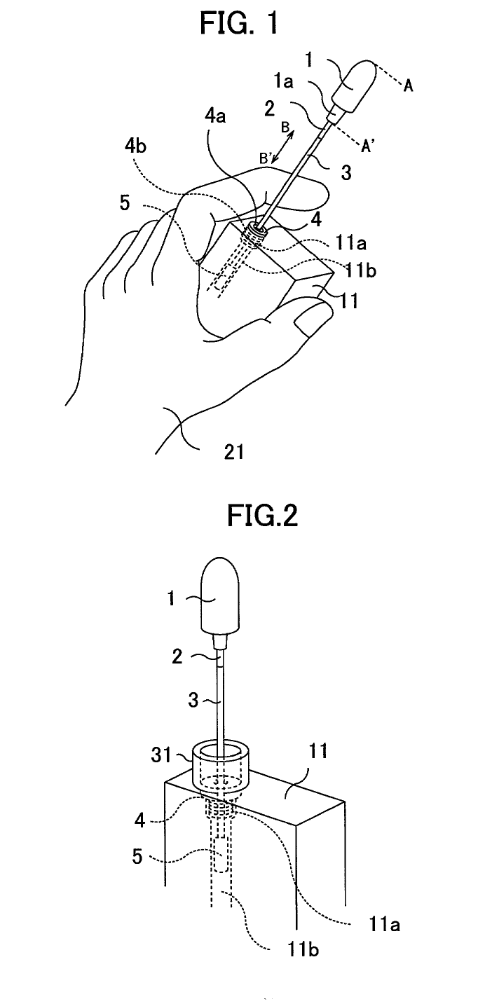

In the following descriptions of the embodiment in reference to FIGS. 2 to 9, same numerals and symbols are used for portions corresponding to those indicated in FIG. 1, and their descriptions are omitted.

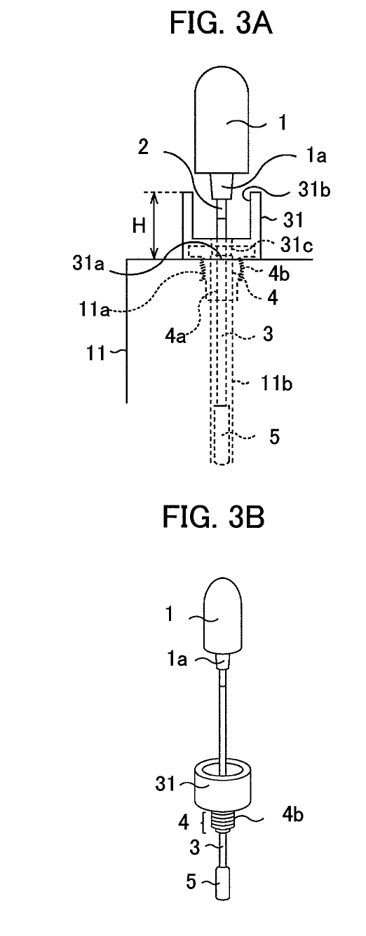

A feature of the portable telephone according to the present embodiment resides in that a protection portion 31 is provided as to protrude from the housing 11. As shown in FIG. 3, the protection portion 31 which protrudes from the housing 11 is formed into a cylindrical shape with a hole 31a which is provided in the center thereof to be aligned coaxial with the hole 11b of the housing 11 for allowing the antenna element 3 to slide therethrough. Further, the protection portion 31 is provided with a major diameter concave portion 31b and a minor diameter concave portion 31c which are formed coaxially along an axis of the hole 31a thereof. The major diameter concave portion 31b has a diameter which is approximately same to the diameter of the top section 1 or slightly larger than that. Further, the minor diameter concave portion 31c has a diameter which is approximately same to the diameter of the sleeve 1a of the top section 1 or slightly larger than that. Therefore, when the antenna element 3 is retracted into the hole 11b of the housing 11, the lower cylindrical member of the top section 1 is withdrawn to fit into this major diameter concave portion 31b and at the same time the sleeve 1a of the top section 1 is withdrawn to fit into the minor diameter concave portion 31c.

Further, the protection portion 31 is made of resin such as an ABS (acrylonitrile butadiene styrene) copolymer, an elastomer or the like, and the holder 4 is made of a conducting metal. The protection portion 31 and the holder 4 are formed together in such a manner that the holder 4 is partially inserted in advance into a die of the protection portion 31 and the ABS resin or the like is injection-molded in the die (i.e., an upper portion of the holder 4 is embedded in the protection portion 31 in FIG. 3). Namely, they are formed by a so-called insert molding. Further, a screw portion 4b of the holder 4 is screwed into a screw hole 11a of the housing 11. Alternately, the protection portion 31 and the holder 4 may be formed separately and be jointed together with screws, which will be described with reference to FIG. 9. Still further, the protection portion 31 may be formed with any resin other than those described above.

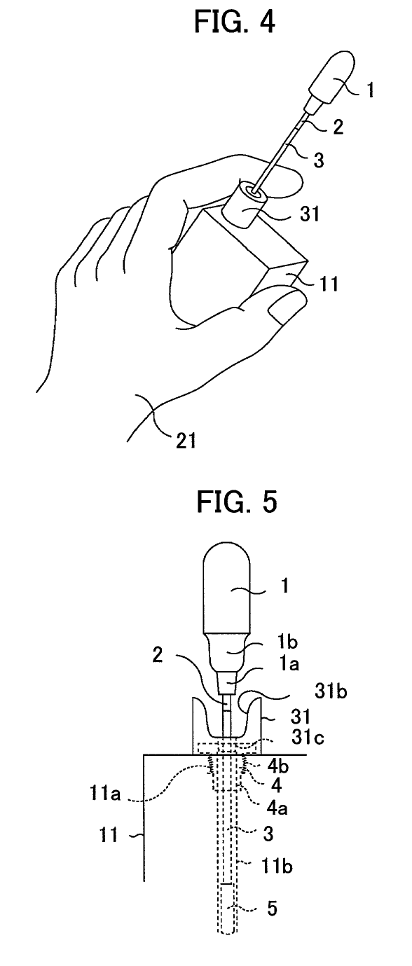

By provision of the antenna device having the arrangement described above, as shown in FIG. 4, even if the user grips the housing 11 with the hand when the antenna element 3 is protracted from the housing 11 to communicate, the hand 21 of the user is prevented from touching the antenna element 3 which is guarded by the protection portion 31. Therefore, preferably, a height H (with reference to FIG. 3) of projected part of the protection portion 31 from the housing 11 is approximately 1 cm to 1.5 cm corresponding to a thickness of the hand or a diameter of the finger of the user. Alternatively, depending on a size of the top section 1, it may be arranged such that substantially a whole portion of the top section 1 is covered with the protection portion 31.

With reference to FIG. 5, another example of the top section 1 with a partially modified shape is disclosed. A curved portion 1b is provided between the top section 1 and the sleeve 1a. In this case, a major diameter concave portion 31b of the protection portion 31 is formed corresponding to a curved surface of the curved portion 1b. Thereby, when the antenna element 3 is retracted into the hole lib in the housing 11, the curved portion 1b of the top section 1 is fitted into the curved surface of the major diameter concave portion 31b, and also the sleeve 1a is fitted into the minor diameter concave portion 31c.

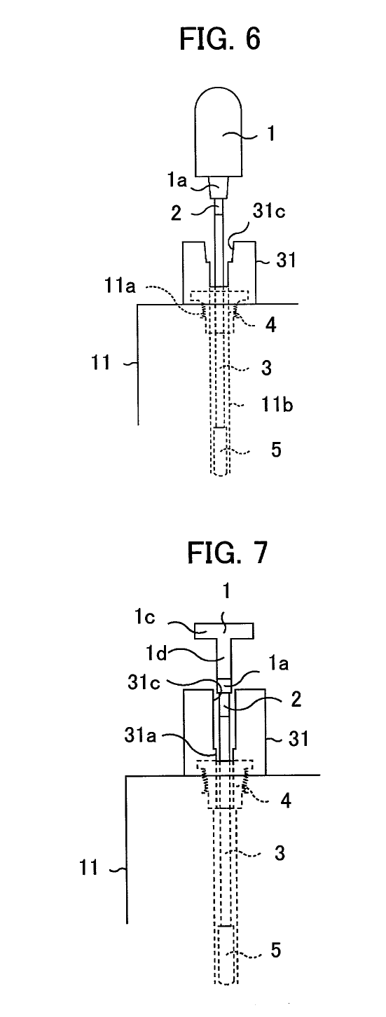

With reference to FIG. 6, another example of the protection portion 31 having only a minor diameter concave portion 31c is disclosed. Because only the minor diameter concave portion 31c is provided in the center of the protection portion 31, when the antenna element 3 is retracted into the hole lib in the housing 11, while the sleeve 1a is fitted into the minor diameter concave portion 31c, the top section 1 is stopped thereupon protruding from the protection portion 31 with its upper semispherical portion and its lower cylindrical portion exposed. According to the above-mentioned arrangement as shown in FIG. 6, a thickness of the protection portion 31 is increased thereby substantially improving a mechanical strength thereof.

With reference to FIG. 7, still another example of the antenna device of the present embodiment is shown, wherein the top section 1 is formed to have a disc portion 1c provided on its top and a shaft id provided in the bottom thereof so as to have a T-shaped form when viewed from the side. In this case, the shaft id of the top section 1 has approximately the same diameter as that of its sleeve 1a, therefore, only the minor diameter concave portion 31c is provided in the center of the protection portion 31. When the antenna element 3 is retracted, the top section 1 is stopped with the disc portion 1c thereof mounted on the upper surface of the protection portion 31 and with the shaft id and the sleeve 1a thereof fitted into the minor diameter concave portion 31c of the protection portion 31.

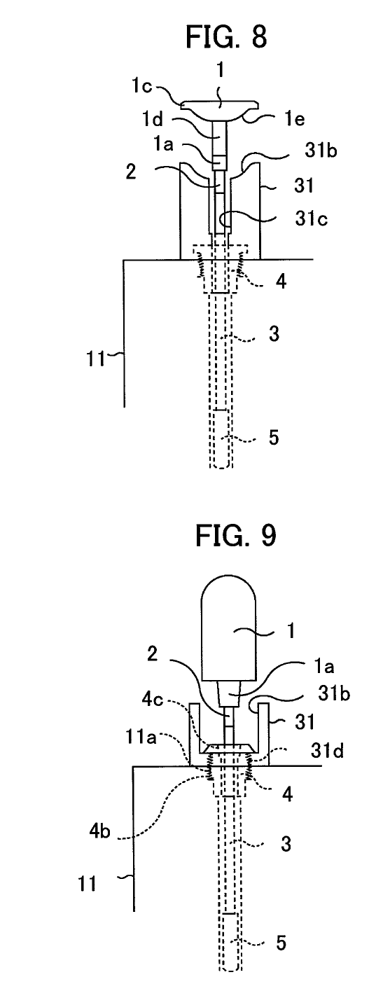

With reference to FIG. 8, a modified version of the example of FIG. 7 is described, wherein a curved portion 1e is provided below the disc portion 1c of the top section 1. In this case, the major diameter concave portion 31b is formed in the upper surface of the protection portion 31 corresponding to the curved surface of the curved portion 1e of the top section 1. Further, because a diameter of the shaft 1d of the top section 1 is approximately same to a diameter of the sleeve 1a thereof, only the minor diameter concave portion 31c is provided in the center of the protection portion 31. When the antenna element 3 is retracted, the top section 1 is stopped with the disc portion 1c thereof mounted on the upper surface of the protection portion 31, with the curved portion 1e thereof fitted into the major diameter concave portion 31b of the protection portion 31, and with the shaft id as well as the sleeve 1a fitted into the minor diameter concave portion 31c.

With reference to FIG. 9, an example is described. In this example, the protection portion 31 and the holder 4 are provided in such way that they can be separated. Namely, in this example, the protection portion 31 is provided with a screw hole 31d approximately of the same diameter as a diameter of a screw 4b of the holder 4, instead of the hole 31a provided in the preceding examples. The screw 4b of the holder 4 is screwed into the screw hole 31d of the protection portion 31 from the above after it is mounted on the housing 11 as aligned collinear with an axis of the screw hole 11a in the housing 11, until it is screwed into the screw hole 11a in the housing 11 penetrating through the holder 4, thereby jointing the protection portion 31 to the housing 11 with the screw coaxially with respect to the antenna element 3.

The protection portion 31 having the above-mentioned structure according to the present embodiment may be applied also to existing portable telephones. Further, if only the antenna device is broken, it may be replaced easily with a new antenna device while using the protection portion 31 as it is. Alternatively, if only the protection portion 31 is broken, it may be replaced with a new one without need of replacing the antenna device.

In addition, because the protection portion 31 is formed non-integral with the antenna device, a degree of freedom in the design of the antenna device is not restricted.

Heretofore, the embodiments of the present invention has been described by way of example of the antenna device in combination of the helical antenna embedded in the top section 1 which is used when the antenna element 3 is retracted into the housing 11 and the monopole antenna which is used when the antenna element 3 is protracted. However, it is not limited thereto, and this monopole antenna may be used in combination with other types of antennae such as a top loading antenna, a meandering antenna or the like. Further, a single antenna construction which can serve as a whole antenna device by itself may be adopted. In this case, the joint 2 may be omitted. Still further, the shapes and combinations of the top section 1 and the protection portion 31 may be changed variously other than those described above within the scope of the invention.

Furthermore, hereinabove, the embodiments of the present invention have been described by way of example of the antenna device for use in the portable telephone. However, it is not limited thereto, and the antenna device of the invention may be applied to any other types of portable communication systems provided with an antenna device which is retractable into the housing thereof.

According to the feature of the invention, because of the provision of the protection portion which covers the top section of the antenna device when its rod antenna is retracted into the housing, it is ensured for the antenna element to be protected from being touched with the hand of the user as it is guarded by the protection portion when the antenna element is protracted out of the housing during communication, thereby without deteriorating the characteristics of the antenna, guaranteeing a stable quality of communication.

Although the invention has been described in its preferred form with a certain degree of particularity, obviously many changes, variations and combinations are possible therein. It is therefore to be understood that any modifications will be practiced otherwise than as specifically described herein without departing from the scope of the present invention.

What is claimed is:

1. An antenna device disposed on a housing of a portable communication apparatus comprising:
a rod type retractable antenna portion;
a storage portion for storing said antenna portion within said housing of a portable communication apparatus by sliding said antenna portion along an axial direction thereof; and
a protection portion for covering a part of or a whole top section of said antenna portion for protection when said antenna portion is retracted in said storage portion while said top section of said antenna portion being protruded from said housing.

2. The antenna device as claimed in claim 1, wherein said protection portion is formed separately from said housing.

3. The antenna device as claimed in claim 2, further comprising a joint portion which is formed together with said protection portion and to be jointed with said housing.

4. The antenna device as claimed in claim 2, further comprising a joint portion which is formed separately from said protection portion and disposed to be penetrated through said protection portion to fit said housing, said joint portion being joined with said housing.

5. A portable telephone unit comprising said antenna device as claimed in claim 1.

6. An antenna device for a portable communication apparatus comprising:
an antenna portion;
a storage portion for storing said antenna portion within a housing of said portable communication apparatus; and
a protection portion for covering at least a part of a top section of said antenna portion when said antenna portion is stored in said storage portion, wherein
said protection portion is formed separately from said housing.
